(19) United States
(12) Patent Application Publication
(10) Pub. No.: US 2005/0115278 A1
(43) Pub. Date: Jun. 2, 2005

(54) Sealing a fiber drawing furnace

(76) Inventor: Timo Mattila, Espoo (FI)

Correspondence Address: VENABLE, BAETJER, HOWARD AND CIVILETTI, LLP, P.O. BOX 34385, WASHINGTON, DC, 20043-9998, US

(21) Appl. No.: 10/501,710

(22) PCT Filed: Jan. 14, 2003
(86) PCT No.: PCT/FI03/00020

(30) Foreign Application Priority Data
Jan. 18, 2002 (FI) 20020103

(51) Int. Cl. C03B 37/02

(52) U.S. Cl. 65/533

(57) ABSTRACT

A drawing furnace or the like for manufacturing optical fiber preferably of a vertical fiber preform, which drawing furnace includes at least a preferably tubular heating element surrounding the fiber preform for heating the fiber preform, an outside insulating layer of the heating element, a frame part of the drawing furnace in order to place the heating element and insulating layer in the drawing furnace, and a cover part in order to close the area between the heating element and the frame part to insulate the insulating layer from the gas flow surrounding the fiber preform. A gas tube is fitted between the cover part of the drawing furnace and the heating element in order to feed gas to the gas space surrounding the fiber preform, and the cover part is still fitted mobile in relation to the frame when the length of the heating element changes in such a manner, that a force, which is substantially constant and seals the gas tube to the end of the heating element, is directed at the gas tube in all modes of operation of the drawing furnace.

The invention relates to a drawing furnace for manufacturing optical fiber according to the preamble of the appended claim 1.

The manufacture of optical fiber can be roughly divided into two different phases. A fiber preform is manufactured in the first phase. The fiber preform is a relatively short, rigid and thick quartz glass bar, to which the optical properties of the fiber being manufactured, i.e. a refractive exponent distribution parallel to the radius of the fiber, are formed in connection with the manufacture of said preform. In the next phase the preform is placed in a so-called drawing furnace, wherein the fiber preform is drawn to a thin and flexible optical fiber. In connection with the drawing of fiber, the fiber is also typically coated with one or more buffer coatings before it is reeled up for storage.

In a drawing furnace, which is in a vertical position, the lower end of the fiber preform, which is placed vertically inside the furnace, is typically heated to a temperature of approximately 2000° C. with a heating element, which surrounds the fiber preform symmetrically in the horizontal plane. This heating element is typically made of graphite material, the heating of which is arranged to take place inductively. When the lower end of the fiber preform reaches a temperature which is high enough, gravity draws the fused quartz glass, which is partly in quick condition, downwards, in which case this fiber is thus formed as a continuous process. The diameter of the optical fiber that is formed in the manner described above can be controlled e.g. by adjusting the heating of the fiber preform and by affecting the winding speed, i.e. the drawing speed.

In the manufacture of optical fiber with a drawing furnace, impurities, which drift to the fiber as fine particles, form a significant and well-known problem as such. These particles may originate either from outside or inside the drawing furnace. Typically the impurities originating from the inside of the drawing furnace loosen from the heating element, insulating material or other high temperature parts of the furnace. The particles are typically, for example, silicon carbide or carbon. The glass material loosening from the fiber preform itself may form particles, which disturb the process. When meeting the fused quartz glass forming into fiber, the impurity particles mentioned above cause local faults (discontinuity) in the fiber, which affect the strength of the fiber and may at a later stage cause, for example, the fiber to break.

For example, patent publication U.S. Pat. No. 4,547,644 discloses these abovementioned problems caused by impurity particles in fiber drawing. As a solution to the problem, said publication presents sealing means, which have been arranged to the upper and lower ends of the heating element in connection with the insulating layer surrounding the tubular heating element of the drawing furnace, and which are used to decrease the flow of impurity particles to the inside of the furnace. U.S. Pat. No. 4,547,644 presents a solution, which is substantially based on the circular cover structure placed in the upper part of the drawing furnace, which structure keeps, with its own weight, the upper one of the abovementioned sealing means at its place and allows thermal expansion of the insulating material. The sealing reached with the solution is, however, not completely satisfactory, because the sealing of the cover part in relation to the heating element of the drawing furnace and other parts of the furnace is allowed to vary. The solution presented in U.S. Pat. No. 4,547,644 does not enable a precise control of gas flow inside the drawing furnace either.

Flow conditions of the gases inside the drawing furnace are an important factor affecting the quality of the fiber being manufactured. Typically the aim is to arrange the gas flow from up to down, in which case the speed difference between the gas flow and the fiber being formed is as small as possible and no turbulence is formed between them. There is a solution known from background art, wherein a gas flow upwards inside the drawing furnace is used, in which case the particles formed inside the furnace are directed upwards with said gas flow, and thus do not meet the downwards falling fused quartz glass, which is forming into fiber.

The abovementioned solutions of background art have not, however, been able to solve the problems connected with the impurity particles in a totally satisfactory manner. Regardless of the good quality materials used in the heating elements and in other components of the drawing furnace and the special structure solutions developed for sealing the structures of the drawing furnace, some particles, which disturb the drawing of fiber, are still always formed inside the furnace. Using a gas flow directed upwards causes problems in drawing fiber, when the drawing speeds are great, for example over 600 m/s.

The main purpose of the present invention is to present equipment that is used in the manufacture of optical fiber, with which equipment the sealing of the heating part of the furnace is improved and thus the travel of impurity particles to the inside of the drawing furnace and the fiber being formed in the furnace is prevented. In addition, with the invention, control of the flow of gases fed to the drawing furnace is significantly improved, as a result of which the gas flow surrounding the fiber being formed behaves well from the point of view of the fiber forming process.

To attain these purposes, the drawing furnace according to the invention is primarily characterized in what will be presented in the characterizing part of the independent claim 1.

The other, dependent claims will present some preferred embodiments of the invention.

The basic idea of the invention is that when optical fiber is manufactured with a vertical drawing furnace, wherein the fiber preform is heated in the heating zone in such a manner, that thin fiber is formed of the molten being formed at the lower end of the fiber preform with gravity and/or downward drawing aimed at the fiber, the cover part of said drawing furnace is fitted to the structure of the equipment in such a manner, that thermal expansion of the heating element of the drawing furnace cannot change the sealing between the cover part and the heating element. The cover part mentioned in an advantageous embodiment of the invention is fitted mobile in relation to the frame part of the drawing furnace in such a manner, that the location of the cover part in relation to the upper edge of the tubular heating element remains constant when the length of the heating element changes as a result of temperature changes. Typically the length of the heating element of the drawing furnace increases approximately 5 mm when the temperature of the element increases from room temperature to a temperature of approximately 2000° C.

Preferably said cover part is attached to the frame part of the drawing furnace with means, which press the cover part towards the heating element substantially with a constant force, regardless of the length of the heating element, in which case a constant force is directed also at the sealing between the cover part and the heating element, i.e. the inner tubes of the gas tube, and the sealing remains constant. Preferably the pressing force of said means can be adjusted. In an advantageous embodiment of the invention, the means according to the invention are implemented with spring-like structures placed outside the hot space of the drawing furnace.

With the sealing structure according to the invention it is possible to eliminate the indefiniteness in the sealing between the drawing furnace and its surroundings caused by thermal expansion, especially the thermal expansion of the heating element, still, however, allowing the thermal expansion of the heating element. Another significant advantage of the invention is that the gas flow channels of the drawing furnace and thus the gas flows themselves remain unchanged throughout the entire temperature area, in which case the gas can be fitted to flow in the drawing furnace at an optimal speed from the point of view of fiber formation, preferably at the drawing speed of the fiber being formed.

The following more detailed description of the invention, with examples, will more clearly illustrate, for anyone skilled in the art, preferred embodiments of the invention as well as advantages to be achieved with the invention in relation to background art.

In the following, the invention will be described in more detail with reference to the appended drawings, in which

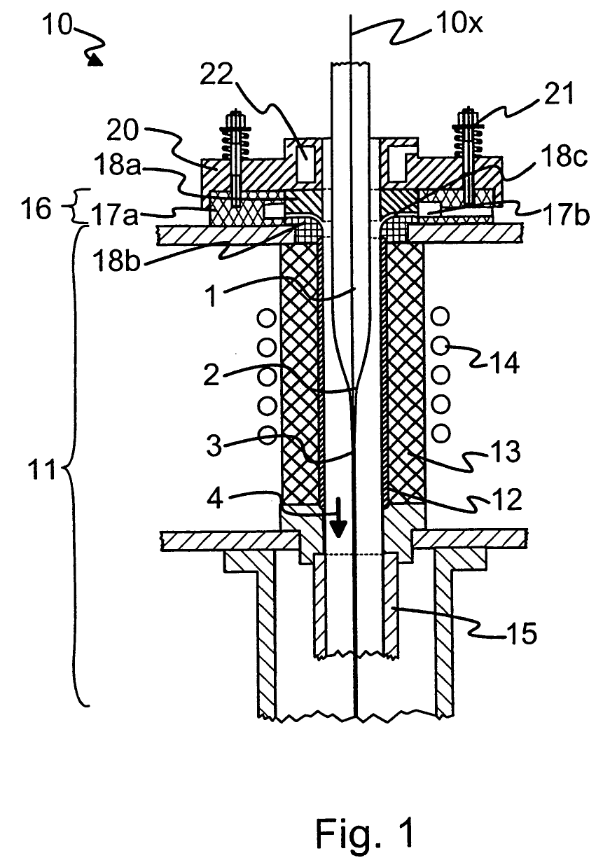

FIG. 1 shows in a side-view, in principle, an embodiment of the invention when the heating element of the drawing furnace is cold, and

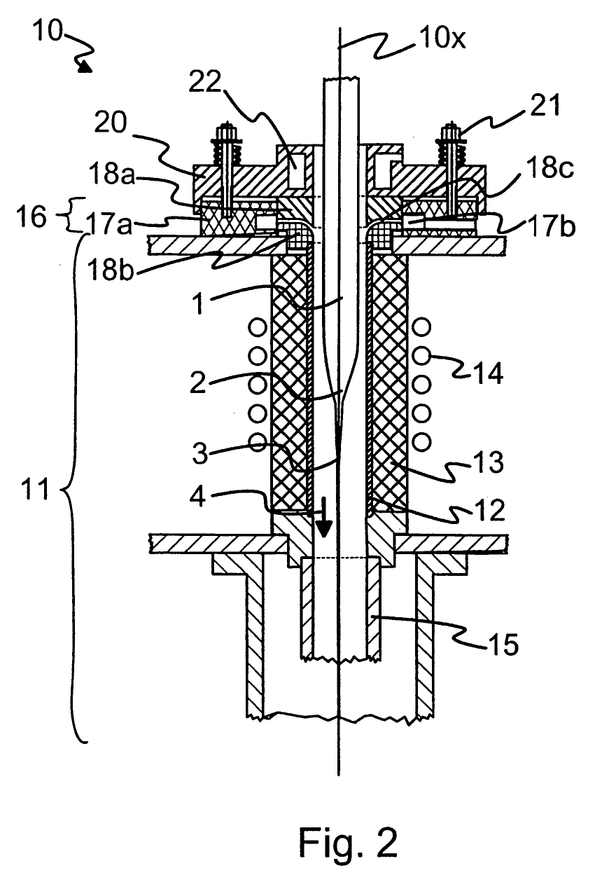

FIG. 2 shows in a side-view, in principle, the embodiment according to FIG. 1 when the heating element of the drawing furnace is hot.

The appended figures are principled and, for better clarity, details irrelevant to understanding the invention have been left out, such as the cooling channels in the upper part of frame part 11 of drawing furnace 10.

FIG. 1 shows, in principle, the structure of the drawing furnace 10 used in manufacturing optical fiber 3 and the location of different parts of the drawing furnace in relation to each other when the drawing furnace is cold.

A quartz glass fiber preform 1, which is typically 50-100 mm in diameter and 500-2,000 mm in length, is placed vertically inside a tubular heating element 12. The material of the heating element 12 is typically graphite, which endures the temperatures of the process, which can be around 2000° C., well. The heating element 12 is surrounded by an insulating layer 13, which can be, for example, porous graphite wool.

Induction coil 14 is arranged to heat the heating element 12 with electric induction, in which case a heating zone is formed against said coil, to which heating zone the lower end of fiber preform 1 is placed. Because of the heating effect of heating element 12, molten 2 is formed at the lower end of the fiber preform 1, which molten further forms to a thin, downwards moving fiber with gravity and/or drawing directed at fiber 3.

In the drawing direction of fiber 3 after the heating element 12, a so-called extension tube 15 is arranged to the drawing furnace 10, the purpose of which tube is to prevent the fiber from cooling too quickly. In order to manufacture good quality optical fiber 3 it is important, that the formed fiber is not subjected to a so-called cold shock. Here, cold shock means that stress states caused by too fast cooling remain in the crystal structure of the fiber 3 being formed, in which case the final crystal structure of the fiber remains imperfect. This weakens the optical properties of fiber 3 significantly, and also affects the mechanical strength of the fiber.

The upper part of the extension tube 15 is advantageously silica tube typically for the 100-500 mm long beginning part. The purpose of this part is to separate the heating element 12 in a high temperature from the lower parts of the drawing furnace 10 (extension tube 15). A silica tube is suited for this purpose because of its high heat resistance, in which case the silica tube itself does not need to be actively cooled, and fiber 3 is thus not subjected to cold shock. Instead of quartz, for example graphite can also be used as material for the extension tube 15. The formation of fiber 3 from fused quartz glass is still ongoing at the silica tube, so therefore a too steep temperature gradient when moving downwards from the area of influence of the heating element 12 would be harmful from the point of view of fiber formation by causing a non-desired cold shock to the fiber.

The downward flow 4 of inert gas, preferably argon gas, is advantageously arranged to the drawing furnace 10. Said gas flow 4 advances typically from the area of influence of the heating element 12 further to the extension tube 15.

In order to create the abovementioned gas flow 4, a gas tube 16 is arranged to the upper part of the drawing furnace 10 according to the invention. Gas tube 16 is formed of an outer tube 17a and inner tubes 18a, 18b arranged inside the outer tube. It is advantageous to place the outer tube 17a and inner tubes 18a, 18b concentrically around the vertical axis 10x of the drawing furnace 10. The gas required for the gas flow 4 of the drawing furnace is fed from outside the furnace to a channel 17b formed on the outer tube 17a. Channel 17b is preferably placed to go around the vertical axis 10x of the drawing furnace 10 horizontally. The vertical axis 10×of the drawing furnace 10 refers to that vertical line of the drawing furnace, on which are the central line in height direction of the drawing space of the drawing furnace, the vertical line of the fiber preform 1, and the vertical line of the fiber 3 being formed.

The upper inner tube 18a and the lower inner tube 18b are surrounded by the outer tube 17 of the gas tube 16. The purpose of inner tubes 18a, 18b is to seal the space between the heating element 12 and the cover part 20 in such a manner, that the insulating layer 13 surrounding the heating element is not in connection with the inside of the furnace, in which state fiber 3 is formed from the fiber preform 1. In a way characteristic to the invention, a hole 18c is formed between the upper inner tube 18a and the lower inner tube 18b as a result of the design of the corresponding surfaces of the inner tubes. In an advantageous embodiment it is possible to form protrusions on the corresponding surfaces of the upper inner tube 18a and the lower inner tube 18b, which protrusions prevent contact between the corresponding surfaces on the entire surface area and, at the same time, the protrusions keep the distance between the tubes constant, in which case also the size of the hole 18c remains constant. It is very advantageous to design the hole 18c between inner tubes 18a, 18b such, that its opening towards the vertical axis 10x of the drawing furnace 10 goes around the vertical axis of the drawing furnace horizontally as a uniform circle. It is also possible to form the inner tubes 18a, 18b of the gas tube 16 from one uniform tube, in which case the gas hole 18c is formed in the said tube, for example, by machining. In addition, it is possible to form the inner tubes 18a, 18b of the gas tube 16 from more than two parts, in which case, for example in order to form gas hole 18c, separate intermediate parts can be used.

Channel 17b of the outer tube 17a of the gas tube 16 and the hole 18c between the inner tubes 18a, 18b are connected to each other, in which case gas can flow from the hole between the inner tubes through the channel of the outer tube to the inside of the drawing furnace, in which case gas flow 4 is created inside the heating element 12 and the extension tube 15.

It is advantageous to manufacture the inner tubes 18a, 18b from a material, whose thermal expansion is as small as possible at the temperature range used, it is especially preferable to use tubes manufactured of graphite. The thermal expansion of graphite tubes, whose height is typically around 10 mm, is, in practice, non-existent. For example, a graphite heating element 12 expands in the drawing furnace 10 on the temperature range used only about 5 mm, even though its total length is around 500 mm. Because of the substantially non-existent thermal expansion of the inner tubes 18a, 18b the hole 18c between the inner tubes remains substantially the same over the entire temperature-range, in which case arranging the gas flow 4 as desired can be easily arranged.

The outer tube 17a of the gas tube 16 is preferable to manufacture of a thermally and mechanically strong material, such as steel. The change in the size of the channel 17b of the outer tube 17a, because of thermal expansion, is irrelevant in practice, if the channel is dimensioned large enough, in which case the gas flow 4 inside the drawing furnace 10 can be kept as desired with the hole 18c between inner tubes 18a, 18b. It is preferable to form the outer tube 17a from one uniform piece, but the outer tube can also be formed of more pieces, if necessary.

When using inner tubes 18a, 18b of the gas tube 16, which are made of material that substantially does not expand thermally, the holes 18c formed in them remain substantially constant in size when the temperature changes, if the pressing force affecting the inner tubes also remains substantially constant. Thus the gas flow 4 through the holes 18c also remains substantially constant. The vertical location of the holes in relation to the outer tube 17a of the gas tube 16 changes when the length of the heating element 12 changes, and this change is to be taken into account when forming the channel 17b of the outer tube 17a of the gas tube, in order to keep gas flow 4 as desired in different operating modes. In the advantageous embodiment according to the example of FIGS. 1 and 2, the channel 17b of the outer tube 17a of the gas tube 16 is formed to be so wide, that it is connected to the hole between inner tubes 18a, 18b for the entire range of the length of heating element 12.

A cover part 20 is arranged over the gas tube 16 in the upper part of the drawing furnace 10, which part closes the connection of the heating element 12 and the insulating layer 13 up to the outside space of the drawing furnace. If necessary, it is possible to arrange cooling to the cover part 20 by using, for example, cooling channels 21 formed to the cover, in which channels a suitable medium is circled, such as cooling water. Cooling the cover part 20 prevents too much heat transferring to the other structures of the drawing furnace.

According to the invention, the cover part 20 is now fitted in relation to the gas tube 16 in such a manner, that the cover part can move vertically. It is advantageous to attach the cover part 20 to the gas tube 16 with flexible fastening means 22, for example by springs, which allow the cover part to move vertically. The change in the vertical length of the heating element 12 creates the vertical movement of the cover part 20, which change is created by the thermal expansion of the heating element 12 following the change of temperature. As a result of the change in the length of the heating element 12 the lower inner tube 18b arranged against the heating element moves vertically substantially a range corresponding to the change in length. In which case the upper inner tube 18a also moves vertically substantially the same range corresponding to the change in the length of the heating element 12. Thus the cover part 20 arranged above the gas tube 16, against the inner tube 18b, moves also vertically when the length of the heating element 12 varies. The movement of cover part 20 is substantially the same as the vertical length change of heating element 12 and the vertical movement of the inner tubes 18a, 18b of the gas tube 16, when the inner tubes substantially are not thermally expanded.

According to the basic idea of the invention, the cover part 20 is arranged in such a manner that a substantially constant force is directed at the inner tubes 18a, 18b between the cover part and heating element 12 in all the modes of operation of the drawing furnace 10. Thus the level of sealing of the upper part of the drawing furnace 10 remains constant in all modes of operation of the drawing furnace, and the level of sealing is also known. The substantially constant force directed at the inner tubes 18a, 18b between the cover part 20 and the heating element 12 is created with fastening means 22, which allow the cover part to move vertically. There can be one or more fastening means 22, preferably from four to six. Preferably the fastening means 22 are arranged symmetrically in relation to the vertical central axis 10x of the drawing furnace 10.

The fastening means 22 can be formed in several different ways. In an advantageous embodiment, a flexible fastening means 22 is formed of an arbor and a spring. The arbor is attached through the cover part 20 to the gas tube 16 and a spring is placed on top of the cover part 20 around the arbor, and a sheet is placed at the end of the spring. The sheet, which has a hole in the middle, is placed around the arbor in such a manner, that the sheet cannot withdraw from around the arbor. The locking of the sheet can be done by, for example, a screw nut at the end of the arbor. By changing the location of the sheet, the pressing force of the spring is affected and thus the pressing forces affecting the boundary surfaces of the inner tubes 18a, 18b. From the point of view of the desired function of the sealing, it is essential that the flexing area of the fastening means 22 covers at least the area, over which the length of the heating element 12 may vary. If the play of the fastening means 22 ends before the varying of the length of the heating element 12, this results in the pressing forces of the sealing changing.

In another advantageous embodiment, the fastening means 22 is formed of an arbor and a weight. First, the arbor is attached through the cover part 20 to the gas tube 16 in such a manner, that the cover part can move parallel to the arbor. After this, one or more weights are placed on top of the cover part 20 around the arbor. The total mass of cover part 20 and the weight creates a constant pressing force to the inner tubes 18a, 18b of the gas tube. It is possible for the length of the heating element to vary, and at the same time, to move the inner tubes 18a, 18b of the gas tube 16 and the cover part 20 vertically, without the pressing force directed at the sealing changing.

In one embodiment of the invention the pressing force of the cover part 20 is created pneumatically, and it is clear, that the invention is not dependent on the manner the pressing force is created.

FIG. 2 presents, in principal, the drawing furnace 10 according to the embodiment of FIG. 1, and the mutual location of the different parts of the oven when the heating element 12 is hot and it is longer than in the rest position shown in FIG. 1 because of thermal expansion. Rest position refers to a state when the heating element 12 of the drawing furnace 12 is cold.

The length of the heating element 12 grows in relation to the length of the rest position when the temperature increases. When the vertical length of the heating element 12 has increased, also the inner tubes 18a, 18b of the gas tube 16 have moved upwards substantially the corresponding length. In the example, the cover part 20 of the drawing furnace 10 is attached flexibly in relation to frame 11, in which case also the cover part has moved upwards in relation to the frame part, substantially the range corresponding to the change in the length of the heating element 12. The sealing force between the cover part 20, the inner tubes 18a, 18b of the gas tube 16, and the heating element 12 is now equivalent to when the heating element is in the rest position, because the fastening means 22 direct a constant force at the cover part 20, irrespective of the vertical position of the cover part.

The pressing force, which affects the boundary surface between the cover part 20 of the drawing furnace 10 and the upper inner tube 18a, and the boundary surface between the upper inner tube and lower inner tube 18b, and the boundary surface between the heating element 12 and the lower inner tube remains substantially constant by the effect of the fastening means 22 over the entire range of the length of the heating element 12. Thus, because of the fastening means 22, which allow the vertical movement of the cover part 20, the sealing between the cover part and the upper inner tube 18a remains constant when the length of the heating element 12 changes, as well as the sealing between the heating element and the lower inner tube 18b.

When the length of the heating element 12 of the drawing furnace 10 varies, the distance between the outer tube 17a of the gas tube 16 and the cover part 20 also changes, which distance is substantially the same as the distance between the lower inner tube 18a and the insulating layer 13, which, for its part, is substantially the same as the change in the length of the heating element in comparison to the rest position.

The method of attaching the cover part 20 according to the invention is not dependent on the channels 17b of the gas tube 16 and the holes 18c used in feeding gas, nor on the cooling channel 21 of the cover part, but the method of attaching according to the invention can be used by retaining its basic idea also in such cover structures, where there are no channels, or in which the purpose of use is something other than the one presented in the example.

By combining the modes and equipment structures presented in connection with the different embodiments of the invention presented above, it is possible to provide various embodiments of the invention, which comply with the spirit of the invention. For example, the gas tube 20 presented in the embodiment can be connected to the same structure with either the cover part 20 or the frame part 11 of the drawing furnace 10, in which case the cover part is attached directly to the frame part. Therefore, the above-presented examples must not be interpreted as restrictive to the invention, but the embodiments of the invention can be freely varied within the scope of the inventive features presented in the claims hereinbelow.

1-10. (canceled)

11. A drawing furnace for manufacturing optical fiber of a substantially vertical fiber preform, the drawing furnace comprising:
a heating element surrounding the fiber preform, for heating the fiber preform;
an outside insulating layer of the heating element;
a frame part of the drawing furnace in order to place said heating element and said insulating layer in the drawing furnace;
a cover part in order to close the area between said heating element and said frame part to insulate the insulating layer and/or the area surrounding the insulating layer from the gas flow surrounding the fiber preform; and
a gas tube fitted between said cover part and said heating element in order to feed gas to the gas area surrounding the fiber preform;
wherein the cover part is further fitted mobile in relation to the frame when the length of the heating element changes in such a manner that a force, which is substantially constant and seals the gas tube to the end of the heating element, is directed at said gas tube in all modes of operation of the drawing furnace.

12. The drawing furnace according to claim 11, wherein the force between the cover part and the heating element can be adjusted.

13. The drawing furnace according to the claim 11, wherein the drawing furnace comprises fastening means for pressing the cover part substantially with a constant force towards the heating element.

14. The drawing furnace according to the claim 12, wherein the drawing furnace comprises fastening means for pressing the cover part substantially with a constant force towards the heating element.

15. The drawing furnace according to claim 13, wherein one or more springs or the like are used as fastening means.

16. The drawing furnace according to claim 14, wherein one or more springs or the like are used as fastening means.

17. The drawing furnace according to claim 13, wherein one or more means, whose pressing force is created with gravity, are used as fastening means.

18. The drawing furnace according to claim 11, wherein the gas tube comprises one or more outer tubes and one or more inner tubes arranged inside the outer tube, which said outer tubes and inner tubes are arranged concentrically in relation to the fiber preform.

19. The drawing furnace according to claim 11, wherein the gas flow to the gas space surrounding the fiber preform is arranged through the channels and the holes placed in the gas tube, the openings of the holes opening to said gas space symmetrically surround the fiber preform substantially in a horizontal plane.

20. The drawing furnace according to the claim 11, wherein the gas flow to the gas space surrounding the fiber preform is arranged through the channels placed in the gas tube and one substantially uniform and horizontal hole, the opening of the hole opening to said gas space surrounds the fiber preform substantially over the entire circle.

21. The drawing furnace according to the claim 20, wherein the gas flow to the gas space surrounding the fiber preform is arranged through the channels placed in the gas tube and one substantially uniform and horizontal hole, the opening of the hole opening to said gas space surrounds the fiber preform substantially over the entire circle.

22. The drawing furnace according to claim 19, wherein the holes/hole form a gas tube between the first inner tube and the second inner tube.

23. The drawing furnace according to claim 20, wherein the holes/hole form a gas tube between the first inner tube and the second inner tube.

24. The drawing furnace according to claim 21, wherein the holes/hole form a gas tube between the first inner tube and the second inner tube.

25. The drawing furnace according to claim 22, wherein the dimensions of the holes/hole placed in the gas tube remain substantially unchanged in all modes of operation of the drawing furnace.

26. The drawing furnace according to claim 1, wherein the heating element is tubular.
